(19) United States
(12) Patent Application Publication
(10) Pub. No.: US 2006/0180412 A1
(43) Pub. Date: Aug. 17, 2006

(54) Linear induction rotary drive system

(76) Inventor: Jerome Andrew Steers, Miami, FL (US)

Correspondence Address: JEROME STEERS, 7900 S.W. 118TH STREET, MIAMI, FL, 33156, US

(21) Appl. No.: 11/054,100

(22) Filed: Feb. 10, 2005

(51) Int. Cl. F16D 55/08; F16D 65/00; F16D 65/36

(52) U.S. Cl. 188/157; 188/72.1; 188/73.1

(57) ABSTRACT

An appropriately modified housing to include braking mechanisms as well as the stator of a Linear Induction Motor mounted in the traditional location and orientation of a disc brake caliper to interact with an appropriately modified disc brake rotor acting as Linear Induction Motor reaction plate and or wheel Linear Induction Motor reaction plate to produce rotational and propulsive force in the subject wheel. The method described results in an electric drive system that can be added onto existing motor vehicles without the need for any significant redesign of the drive train of the vehicle to enable it's use in the vehicle's driving cycle to save energy and increase power and traction as needed.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

This invention relates to a novel application of Linear Induction Motor technology.

There is a need for a simple, robust and easily applied electric drive system. This electric drive system could have applications in the automotive technology field as well as others. It could save energy and reduce air pollution

No present devices handily fit the bill. Current electric drive systems are centralized in the vehicle and are extremely costly, cumbersome and are not easily adapted to needed uses.

### BRIEF SUMMARY OF THE INVENTION

The present invention has utility in saving energy by improving fuel economy. It would also reduce air pollution caused by internal combustion engines. It could bring a new level of reliability and economy to these engines. The electric drive systems, would be very economical to manufacture and acquire. It could be easily applied to automotive drive systems being presently produced as well as being retrofitted to existing vehicles.

Internal combustion engines currently waste more than 60% of the energy from fuel utilized. Substantial energy savings could result if these engines could be prevented from functioning in the most inefficient part of their operating cycle or if a given application could use a significantly smaller and more efficient engine. This electric drive system would provide on demand torque due to the installation of a linear induction motor in the disc brake caliper housing at each wheel of an automobile. The linear induction motor component with appropriate circuitry in the fixed disc brake caliper housing would function as a stator (to generate a traveling electrical field), and a disc brake rotor suitably modified with applicable embedded circuitry within it's mass, to interact with the travelling electrical field generated by the stator attached to the axle of the vehicle (to be repelled or be attracted by it as required), would function as the rotor (or reaction plate) of the motor, thereby creating rotary motion (it is a proven fact that the stator's traveling electrical field induces currents in the reaction plate circuitry thereby creating a secondary electrical field which interacts with the traveling electrical field). A rim/wheel modified with appropriate embedded circuitry (preferably on it's inner edge) in suitably close proximity to the stator, would also function as the reaction plate of the motor. This dual reaction plate arrangement would not be mandatory in all applications, it may sometimes be desirable to have only the disc brake rotor, or only the associated rim/wheel function as the reaction plate of the motor. This Linear Induction Rotary Drive system could be used in an on-demand mode thereby providing additional power to the drive train of a vehicle as needed, or it could provide 100% of the propulsion in a given part of the operating cycle. Note that both the rim/wheel and the brake rotor as widely utilized on currently produced vehicles, already operate in extremely close proximity to the brake caliper housing. Close tolerances (i.e small air gaps) and the strict control and maintenance of these tolerances, between rotor and stator or between stator and reaction plate, are intrinsic to the proper functioning of linear induction motors. By its very nature and as presently applied, a disc brake caliper housing must necessarily function in close proximity to (i.e with very tight clearances or close tolerances) to the disc brake rotor as well as the applicable rim/wheel. These characteristics readily lend themselves to this new application of being components of the Linear Induction Rotary Drive system.

This Linear Induction Rotary Drive system could be used to assist existing internal combustion engine mounted in a mobile vehicle such as an automobile, in moving said vehicle from rest without additional effort from the main internal combustion engine, thereby reducing engine wear and increasing fuel economy because, the engine would not have to work as hard, or use the same amount of fuel normally used to perform such a task. Additionally, by using a smaller engine matched with a Linear Induction Rotary Drive system to power an automobile of a given specification, greater fuel economy and less engine wear, would also be achieved. By using less fuel, air pollution would be reduced also. It could also add power to a vehicle already underway when needed in certain situations such as negotiating a steep hill. Electric drive reliability would be enhanced due to the built in redundancy of having one motor drive at each wheel, brake wear would be reduced due to the braking/retardation effect of switching the motors to function as electrical generators during deceleration (It would recover normally wasted energy at the same time), while on electric drive a vehicle would run silently, (an asset during certain military operations) and provide 4 wheeled drive as needed. Each motor would not have to be very large or very powerful since in a typical application, 4 very compact units would be doing the total work. The Linear Induction Rotary Drive system could be easily and cost effectively retrofitted to any current automotive drive train.

### BRIEF DESCRIPTION OF THE DRAWING

Drawing Figures.

FIG. 1 shows a caliper housing and it's relationship to a disc brake rotor.

FIG. 2 shows a rim/wheel and its relationship to items referenced in FIG. 1

The drawings depicts the fully assembled invention as described.

Reference Numerals in Drawing

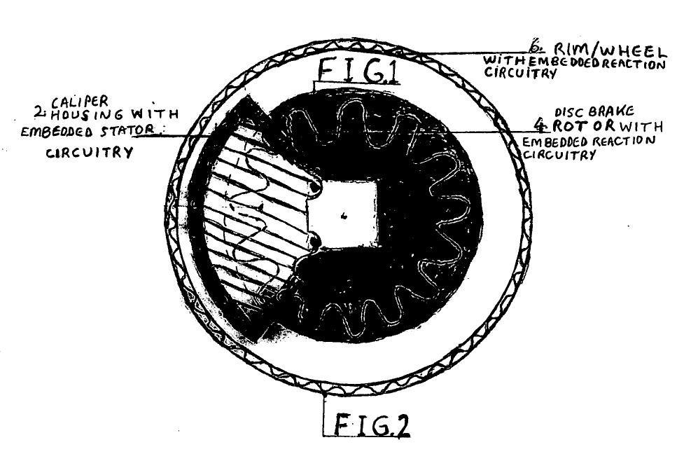

FIG. 1

2. A Caliper Housing With Embedded Stator Circuitry

4. Disc Brake Rotor With Embedded Reaction Circuitry

FIG. 2

6. Rim/Wheel With Embedded Reaction Circuitry

### DETAILED DESCRIPTION OF THE DRAWING

FIG. 1

(2) A Linear Induction Motor Stator unit made of a suitably durable material incorporated in a disc brake caliper housing, (4) A disc brake rotor suitably modified to function as a Linear Induction Motor reaction plate

FIG. 2

(6) A rim/wheel suitably modified to function as a Linear Induction Motor reaction plate.

Although the description above contains many specificities, these should not be construed as limiting the scope of the invention but as merely providing illustrations of some of the presently preferred embodiments of this invention. For example, the Linear Induction Reaction Drive component arrangement and or shape or dimensions could be changed, or they could be constructed of various materials.

Thus the scope of the invention should be determined by the appended claims and their legal equivalents, rather than by the examples given.

Ease of use, increased fuel economy, less air pollution, less engine wear would be realized.

The abovementioned attributes would lead to widespread use and thereby save energy and lower air pollution.

I claim:

1. A Linear Induction Rotary Drive system, comprising:
1. A Linear Induction Motor Stator unit made of a suitably durable material incorporated in a disc brake caliper housing
2. A disc brake rotor suitably modified to function as a Linear Induction Motor reaction plate.
3. A rim/wheel suitably modified to function as linear induction motor reaction plate
Whereby it would be possible to economically construct a rugged, simple, reliable, easily adapted, electric drive system to enable increased fuel economy, less air pollution, and less engine wear.
